(19) United States
(12) Patent Application Publication
(10) Pub. No.: US 2024/0205421 A1
(43) Pub. Date: Jun. 20, 2024

(54) SYSTEMS AND METHODS OF IMPROVING DATA STREAM PROCESSING ACCORDING TO A FIELD-OF-VIEW

(71) Applicant: Meta Platforms Technologies, LLC, Menlo Park, CA (US)

(72) Inventors: Kyunghun Jung, Sunnyvale, CA (US); Kyungho Kim, San Jose, CA (US)

(21) Appl. No.: 18/081,991

(22) Filed: Dec. 15, 2022

(51) Int. Cl. H04N 19/167

(52) U.S. Cl. CPC H04N 19/167; G06F 3/013

(57) ABSTRACT

Systems, methods, and computer readable media for improving data stream processing according to a field-of-view (FOV) may include one or more servers that maintain a relative position of each of a plurality of users with respect to a localized map. The server(s) may receive, from a first device, audio/video (A/V) data of a first user of the plurality of users. The server(s) may receive, from a second device, data indicative of a field-of-view (FOV) of a second user of the plurality of users. The server(s) may transmit, to the second device, rendering data corresponding to the first A/V data at a bit rate selected according to the data indicative of the FOV and/or a relative position of the second user with respect to the localized map.

### FIELD OF DISCLOSURE

The present disclosure is generally related to wireless communication between devices, including but not limited to, systems and methods of improving data stream processing according to a field-of-view for wireless devices.

### BACKGROUND

Augmented reality (AR), virtual reality (VR), and mixed reality (MR) are becoming more prevalent, which such technology being supported across a wider variety of platforms and device. Some devices may be configured for video or audio calling and/or conferencing.

### SUMMARY

Various aspects of the present disclosure are directed to systems, methods, and computer readable media for improving data stream processing according to a field-of-view (FOV). One or more servers may maintain a relative position of each of a plurality of users with respect to a localized map. The server(s) may receive, from a first device, audio/video (A/V) data of a first user of the plurality of users. The server(s) may receive, from a second device, data indicative of a field-of-view (FOV) of a second user of the plurality of users. The server(s) may transmit, to the second device, rendering data corresponding to the first A/V data (e.g., processed/compressed/encoded/formatted) at a bit rate (e.g., corresponding to a first image quality or fidelity) selected according to the data indicative of the FOV and/or the relative position of the second user with respect to the localized map.

In some embodiments, the server(s) may receive, from the first device, second data indicative of a second FOV of the first user. The server(s) may receive, from the second device, second A/V data of the second user. The server(s) may transmit, to the first device, rendering data corresponding to the second AV data processed/compressed/encoded/formatted at a second bit rate (corresponding to a second image quality/fidelity) selected according to the second data indicative of the second FOV and the relative position of the first user with respect to the localized map. In some embodiments, the server(s) may select the bit rate from a plurality of bit rates according to a position of the second user with respect to the FOV of the first user.

In some embodiments, the server(s) may maintain a location index for each user of the plurality of user, the location index indicative of a position of the user with respect to at least some of the plurality of users in the localized map. The server(s) may identify, according to the location index for the second user and the FOV of the second user, a subset of location indices for a subset of users within the FOV of the second user. The server(s) may select a bit rate for compressing A/V data of the subset of users within the FOV of the second user to the higher than bit rates for compressing A/V data of other users of the plurality of users outside the FOV. In some embodiments, the server(s) may select the bit rates for compressing the A/V data of the other users, according to a proximity of the location index for the other users with respect to the FOV. In some embodiments, the bit rate for compressing the A/V data of a respective user of the other users increases as the proximity of the location index for the respective user decreases with respect to the FOV.

In some embodiments, the data indicative of the FOV of the second user includes at least one of directional data indicative of a gaze of the second user, a vector, angular span or coordinates corresponding to the FOV, or identifiers corresponding to a subset of the plurality of users having respective positions within the FOV of the second user. In some embodiments, the A/V data includes three-dimensional (3D) video data and spatial audio data.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is an example view of a holographic calling or communication session through a head-wearable device (HWD), according to an example implementation of the present disclosure.

FIG. 6 is a block diagram of a system for holographic communication, according to an example implementation of the present disclosure.

FIG. 7 is a graphical representation of a virtualized map, according to an example implementation of the present disclosure.

FIG. 8 includes illustrations of various views of an imaging system, according to an example implementation of the present disclosure.

FIG. 9 includes example images corresponding to video data that may be captured by the imaging system, according to an example implementation of the present disclosure.

FIG. 10 is a diagram of an end-user system in communication with the server, according to an example implementation of the present disclosure.

FIG. 11A and FIG. 11B are examples of frames of video data from three different user-end systems prior to and following scaling modification, according to example implementations of the present disclosure.

FIG. 12 is a flowchart showing an example method of updating a session condition of user-end systems, according to an example implementation of the present disclosure.

FIG. 13 is a flowchart showing an example method of updating a field-of-view (FOV) of a device, according to an example implementation of the present disclosure.

FIG. 14 is a flowchart showing an example method of managing bit rates for objects in a communication session, according to an example implementation of the present disclosure.

FIG. 15 is a flowchart showing an example method of signaling information for holographic communications, according to an example implementation of the present disclosure.

FIG. 16 is a flowchart showing an example method of improving data stream processing according to a field-of-view, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

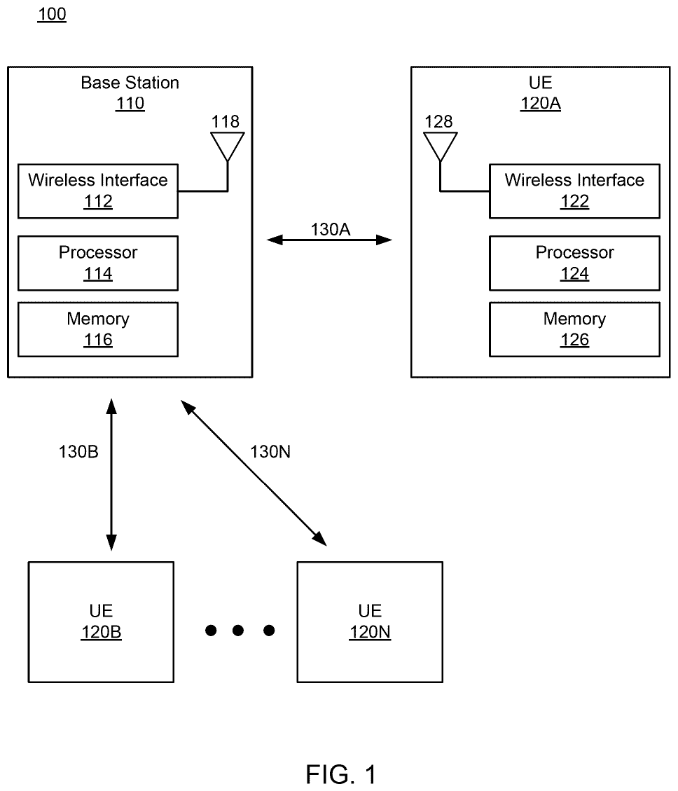

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

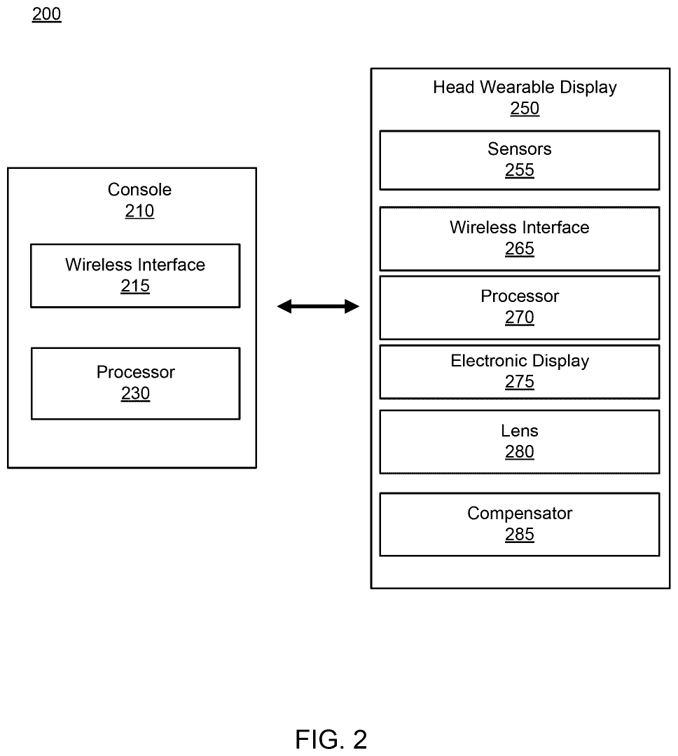

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

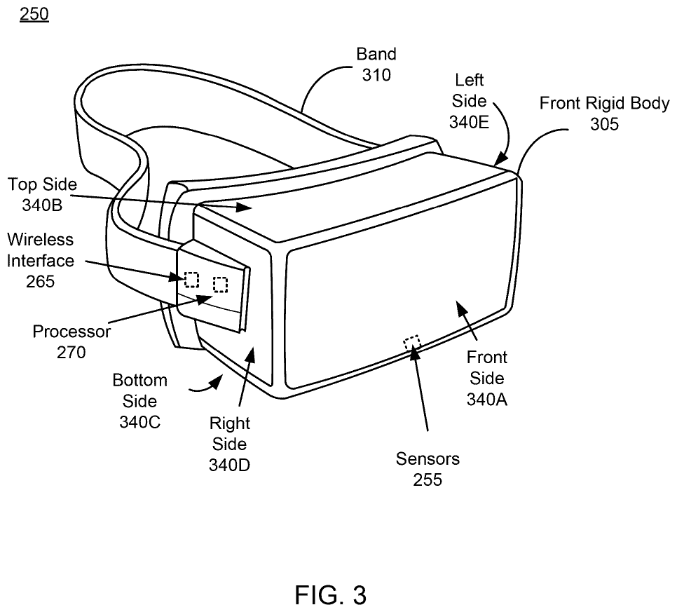

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

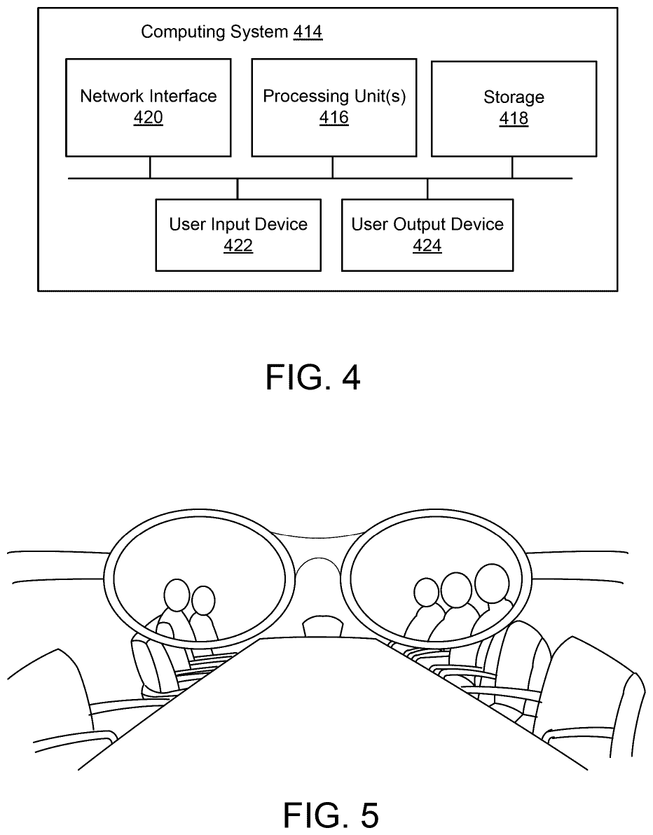

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

### Systems and Methods for Holographic Communication

Referring now to FIG. 5, depicted is an example view 500 of a holographic calling or communication session through a head-wearable device (HWD) 606, according to an example implementation of the present disclosure. Holographic calling or communication may be or include a service provided by XR/AR/VR/MR devices, such as smart glasses or other HWD (such as HWD 606). The service may provide users the ability to communicate with others represented in a three-dimensional (3D) graphic overlaid atop a physical/spatial environment of the user visible via the display (e.g., of the AR glasses and/or VR headset). In various embodiments, a location and direction of other users or objects displayed to the user can be determined by one or more servers and/or by the smart glasses, HWD, or other device communicably coupled thereto.

To provide holographic communication, various imagers and/or microphones may capture audio/video (A/V) data of a user (e.g., from various angles, directions, perspectives, locations). The imagers and/or microphones may communicate the A/V data (e.g., via a tethered/connected smartphone or other user device) to a server. For example, the user device receiving the A/V data may compress/format/encode/process the A/V data and may transmit the compressed/formatted/encoded/processed A/V data to the server. The server, upon receiving the compressed/formatted/encoded/processed A/V data, may transmit the compressed/formatted/encoded/processed A/V data to another device (such as another smartphone or user device associated with another user of the holographic communication session). The other device may receive and reconstruct the media for rendering on a HWD. For example, the other device may transmit the rendered media to the HWD in various formats for rendering to the other user. Where the holographic communication session includes multiple users (e.g., three or more), the server may gather and process the A/V data for each user.

Where the holographic communication session includes multiple users, the server may apply various considerations as part of processing the A/V data. For example, video data of a particular user or object should be scaled in size representation to match a size of a background along with other users or objects. Similarly, audio data can be spatially reconstructed/re-mapped to match the location of the corresponding user on the display. Additionally, where multiple users are participating in the holographic communication session, the server may virtually locate each user in a fixed location relative to other users.

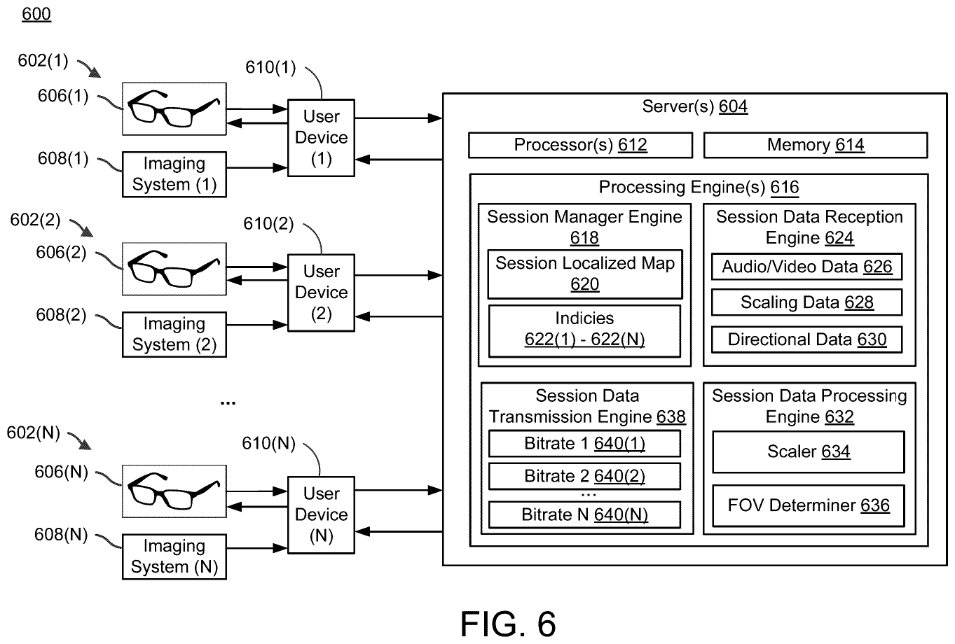

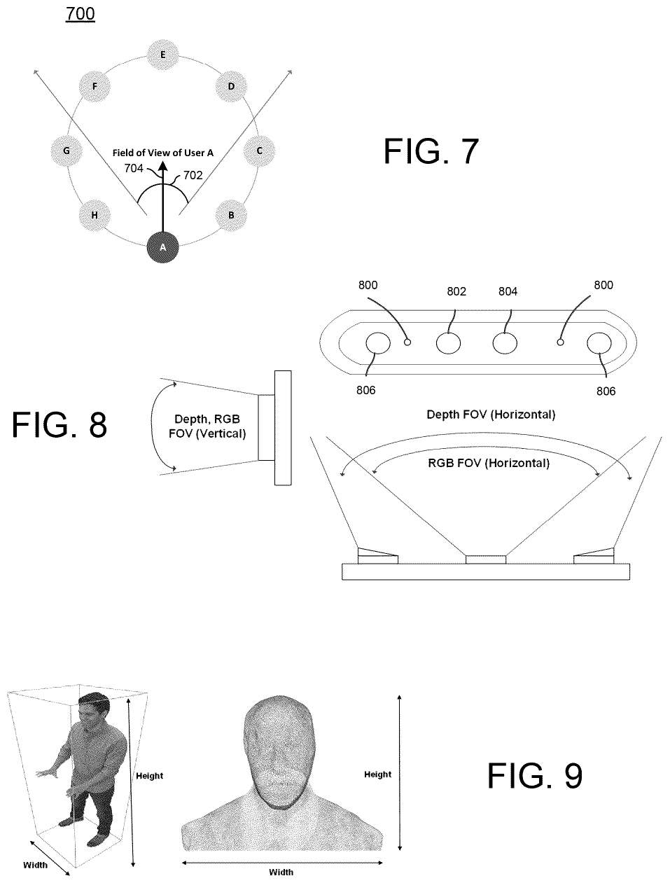

Referring now to FIG. 6, depicted is a block diagram of a system 600 for holographic communication, according to an example implementation of the present disclosure. The system 600 may include a plurality of user-end systems 602 communicably coupled to one or more servers 604. The user-end systems 602 may include a respective head wearable device (HWD) 606, such as a virtual reality (VR) headset, augmented reality (AR) smart glasses, or other device. The HWD 606 may be similar to (or include hardware/software/components similar to) the HWD 250 described above. The HWD 606 may be configured to display or augment graphics on an environment, including a physical (or real-world) environment in embodiments in which the HWD 606 is an AR HWD 606, or a virtual environment in embodiments in which the HWD 606 is a VR HWD 606. The user-end systems 602 may include an imaging system 608. The imaging system 608 may be configured to capture, at least, video data of a user corresponding to the user-end system 602. Additional details regarding the imaging system 508 are described with reference to FIG. 7. The user-end systems 602 may include a user device 610. The user device 610 may be or include hardware similar to the UE 120 described above with reference to FIG. 1. For example, the user device 610 may include a smart phone, a mobile device, a tablet, a laptop, or other user device. While shown as separate devices, in various embodiments, two or more of the devices of a respective user-end system 602 may be combined into a single device. For example, the imaging system 608 may be a component of hardware of the user device 610.

As described in greater detail below, and according to various embodiments, each of the user systems 602 may establish a holographic communication session with the server 604. The imaging system 508 of the respective user-end systems 602 may be configured to capture audio/video (A/V) data of a respective user, and can transmit the A/V data (e.g., via a local connection or link) to the user device 610. In some embodiments, the imaging system 608 may be configured to capture scaling data indicative of a size, proportion, dimension, or scale of the user or object of the A/V data. The imaging system 608 may be configured to transmit the scaling data to the user device 610. Additionally, and in various embodiments, the HWD 606 may be configured to capture directional data indicative of a gaze of the respective user, and the HWD 606 may be configured to transmit the directional data to the user device 610. The user device 610 may be configured to communicate, transmit, send, or otherwise provide the A/V data, scaling data, and/or directional data to the server 604. The server 604 may be configured to receive the A/V data from each of the user-end systems 602, along with the scaling data and directional data. The server 604 may be configured to manage the holographic communication session by controlling various aspects of the A/V data according to the scaling and directional data, and may communicate the modified A/V data corresponding to one respective user to user-end systems of other users for rendering (e.g., via the respective HWDs 606).

The server(s) 604 may include one or more processors 612. The processors 612 may be similar to the processors 114, 124, 230, 270 described above with reference to FIG. 1 and FIG. 2 and/or the processing units 416 described above with reference to FIG. 4. The server(s) 604 may include memory 614. The memory 614 may be similar to memory 116, 126 described above with reference to FIG. 1 and/or storage 418 described above with reference to FIG. 4. The server(s) 604 may include one or more processing engine(s) 616. The processing engine(s) 616 may be or include any device, component, element, or hardware designed or configured to perform various functions or tasks relating to the server(s) 604. For example, the processing engine(s) 616 may be configured to perform various functions relating to establishing and management of a holographic communication session across multiple user-end systems 602, as described in greater detail below. It is noted that various processing engine(s) 616 described herein could be sub-divided into multiple additional processing engine(s) 616, and additionally or alternatively, various processing engine(s) 616 described herein could be combined into a single processing engine 616.

The server(s) 604 may include a session manager engine 618. The session manager engine 618 may be configured to establish and/or maintain a holographic communication session across multiple user-end systems 602. In some embodiments, the session manager engine 618 may be configured to establish the session responsive to receiving a request from each of the user devices 610 to establish the session. For example, a first user of the first user-end system 602(2) may access an application or resource on the user device 610(1) to initiate the holographic communication session with the other user devices 610(2)-610(N) (e.g., by dialing a number or username or other user identifier associated with the user devices 610(2)-610(N)). The user device 610(1) may transmit a request to initiate the holographic session to the server(s) 604, along with an identifier for the other user devices 610(2)-610(N). The session manager engine 618 may be configured to receive the request, and can establish a session according to the request. The session manager engine 618 may be configured to transmit or forward requests to join the session to the other user devices 610(2)-610(N) using the identifier for the other user devices 610(2)-610(N).

Referring to FIG. 6 and FIG. 7, the session manager engine 618 may be configured to maintain, for each session, a localized map 620 including an index 622 associated with each user-end system 602 included in the session. Specifically, FIG. 7 depicts a graphical representation 700 of a virtualized map 620, according to an example implementation of the present disclosure. The localized map 620 may include a table including locations and relative positions of each of the users associated with a respective user-end system 602, such as Table 1 below.

TABLE 1
Localized Map for Holographic Communication Session

| Posi- | | | Device |
|---|---|---|---|
| tion | Neighboring Devices (L, R) | Device ID | Name |
| A | (User Device (N), User Device (2)) | AAAAAAA | User |
| | | | Device (1) |
| B | (User Device (1), User Device (3)) | BBBBBBB | User |
| | | | Device (2) |

. . .

| | | | |
|---|---|---|---|
| N | (User Device (N-1), User Device (1)) | NNNNNNN | User |
| | | | Device (N) |

In Table 1 above, each row of the table may be an index 622 corresponding to a particular user device 602. Each index may include a position which corresponds to a location of the user within the graphical representation 700. For example, a user corresponding to the user device 610(1) may be located at position A, a user corresponding to the user device 610(2) may be located at position B, etc. User-end systems 602 may be assigned a position in the virtualized map randomly, on a first-come-first serve basis, according to various user-defined rules, etc. While shown as a round-table type graphical representation, in various embodiments, the session manager engine 618 may be configured to receive a type or setting for each user-end system 602. For example, one user of the first user-end system 602(1) may be seated at a round table, while another user of the second user-end system 602(2) may be seated at a rectangular table. The session manager engine 618 may be configured to receive, e.g., from the first and second user devices 610(1), 610(2) as part of joining the session, a physical setting of the respective users. The session manager engine 618 may be configured to incorporate such information into the index for the corresponding user.

As shown in Table 1, each index 622 may include data indicating neighboring devices and/or users within the localized map 620. As such, each user, while they may have a different physical setting, may be “virtually seated” or positioned next to the same users across sessions. Continuing the example shown in FIG. 7 and with reference to Table 1, the index for the first user may include data which identifies devices of other user-end systems 602 on the first user's right and left, such as the second user located at position B (or the user associated with the second user-end system 602(2)) and N-th user (e.g., where eight users are in the holographic communication session, the N-th user may be located at position H). Similarly, the index for the second user (e.g., user-end system 602(2)) may include data which identifies the first user (e.g., the user device 610(1) associated with the first user of the first user-end system 602(1)) and a third user located in the third position C. As new users enter the holographic communication session, the session manager engine 618 may be configured to update the session localized map 620 and can add an index 622 for the new user according to the updated localized map 620.

Referring back to FIG. 6, the server(s) 604 may include a session data reception engine 624. The session data reception engine 624 may be configured to ingest, identify, manage, or otherwise receive session data from each of the plurality of user-end systems 620. The session data reception engine 624 may be configured to maintain or manage data streams, together with the session data transmission engine 638, to maintain data flow between the user-end systems 620 to provide the holographic communication session.

Referring now to FIG. 6 and FIG. 8, the user-end systems 602 may include various devices for capturing the session data for transmission to the server(s) 604. Specifically, FIG. 8 shows various views of an imaging system 608, according to an example implementation of the present disclosure. While shown as a separate imaging system 608, in various embodiments, each of the components of the imaging system 608 may be incorporated into or included with the user device 610. In other words, the imaging system 608 may be an imaging system of the user device 610.

The imaging system 608 may be configured to capture audio/video (A/V) data of a user of the user-end system 602. In some embodiments, the imaging system 608 may be configured to capture spatial audio via two or more microphones 800 and three-dimensional (3D) video via various laser emitters 802, color or image (e.g., red-green-blue (RGB)) sensors 804, depth sensor(s) 806, etc. The two or more microphones 800 may form a stereo audio capture system. Similarly, while shown as using a laser emitter 802, color or image sensor(s) 804 and depth sensor(s) 806, in various embodiments, to capture 3D video, the imaging system 608 may include two or more cameras arranged to form a stereo video capture system configured to capture 3D video. As illustrated in FIG. 8, the imaging system 608 may include a depth field-of-view (FOV), an image sensor FOV, in both the latitudinal (or horizontal) direction and longitudinal (or vertical) direction.

The imaging system 608 may be configured to communicate, transmit, send, or otherwise provide data corresponding to the FOVs of the imaging system 608 to the user device 610. In some embodiments, the imaging system 608 may be configured to provide the data to the user device 610 as part of establishing or otherwise enrolling in the session (for example, as part of negotiating a local link or connection between the imaging system 608 and the user device 610). The imaging system 608 may be configured to provide the data as a range or number of bits or pixels in the lengthwise, widthwise, and/or depthwise direction. The imaging system 608 may be configured to transmit data regarding the microphones, such as microphone type and direction of the stereo microphones (e.g., left and right direction, for example).

Referring now to FIG. 8 and FIG. 9, the imaging system 608 may be configured to transmit, send, or otherwise provide A/V data captured by the imaging system 608 to the user device 610. Specifically, FIG. 9 shows example images corresponding to video data that may be captured by the imaging system 608, according to an example implementation of the present disclosure. The imaging system 608 may be configured to capture the video data of the A/V data as a point cloud, a mesh, RGB-depth (RGB-D), etc. The imaging system 608 may be configured to capture, detect, or otherwise determine a height and width of the user or object represented by the video data. In some embodiments, the imaging system 608 may be configured to estimate the height and width of the user or object based on a range or distance from the imaging system 608 to the object or user (e.g., individual points on the user as detected by the imaging system 608), together with the FOV data and a percentage or ratio of the object/user relative to the FOV. The imaging system 608 may be configured to compute a value (e.g., a 12-bit unsigned integer) for representing the height or width of the user (e.g., spanning from 0-4095 mm, for example). The imaging system 608 may be configured to transmit, send, or otherwise provide the values representing the height and width (e.g., together referred to as scaling data) to the user device 610.

In some embodiments, the imaging system 608 may be configured to compute the distance between each point of a point cloud and a vertical plane including the depth sensor, according to various intrinsic and extrinsic qualities of the imaging system 608. For example, the imaging system 608 may be configured to compute or otherwise determine a rotation and translation from a 3D physical world coordinate system to a coordinate system of the imager. The imaging system 608 may be configured to determine an intrinsic matrix K for the imaging system according to various parameters of the imaging system 608. The imaging system 608 may be configured to determine the intrinsic matrix K as

$$K = [ \begin{matrix}fx & 0 & 0 \\ s & fy & 0 \\ cx & cy & 1\end{matrix} ]$$

Variables or parameters used for computing the intrinsic matrix K are shown in Table 2, and may be determined or otherwise provided by an operating system of the imaging system 608.

TABLE 2
Parameters for Determining Intrinsic Matrix for Imaging System

| Parameter | Unit | Definition | Note |
|---|---|---|---|
| fx | float | X-axis focal length (in pixel) | |
| fy | float | Y-axis focal length (in pixel) | |
| cx | float | X-axis principle point (in pixel) | |
| cy | float | Y-axis principle point (in pixel) | |
| s | float | Skew coefficient | Zero if image axes |
| | | | are perpendicular |

The imaging system 608 may be configured to determine or generate a point cloud from a pair of RGB-D frames by reversing the transformation using the intrinsic matrix K. In various embodiments, the imaging system 608 may be configured to determine the size of an object or person in the video data using one or more applications or resources of the imaging system 608 which provide a bounding box or cube around an object to show measured values (e.g., in length, width, and height). The imaging system 608 may be configured to set a minimum size for the bounding box or cube, such that the bounding box tightly fits around the object or user, thus providing a more accurate measurement of dimensions of the object or user.

The imaging system 608 may be configured to transmit the scaling data in a real-time transport control protocol (RTCP) packet to the user device 610. In some embodiments, the imaging system 608 may be configured to transmit the scaling data periodically and/or on-demand. The RTCP packet may include a packet type, an object identifier, a width, and a height. For example, the RTCP packet can have a format including four bits for packet type (e.g., indicating that the RTCP includes size information of a person or object), four bits for object identifier (e.g., indicating or identifying the person or object in the video data), and 12 bits for both width and height of the person or object (e.g., spanning, for example, 0 to 4095 for both the width and height).

The HWD 606 may be configured to communicate, transmit, or otherwise provide directional data to the user device 610. The directional data may be or include a position, orientation, direction, or other directional data indicative of a gaze of a wearer of the user. In some embodiments, the HWD 606 may be configured to provide the directional data as an 8-bit signed integer representing a direction for each axis (e.g., in the X axis, or latitudinal axis, and in the Y axis, or longitudinal axis). The HWD 606 may be configured to measure the directional data based on a relative position with respect to True North, based on a relative position with respect to a fixed device or location (such as the imaging system 608) and so forth. For example, the HWD 606 may include an accelerometer, gyroscope, or other motion sensor configured to measure a position or movement of the HWD 608 (e.g., relative to an axis or plane of the HWD 606). The HWD 606 may be configured to determine the directional data based on or according to the measurements from the motion sensor of the HWD 606. The HWD 606 may be configured to transmit the directional data to the user device 610.

The HWD 606 may be configured to transmit the directional data to the user device in an RTCP packet. Similar to the RTCP packet including the scaling data, the HWD 606 may be configured to transmit the RTCP packet with the directional data on-demand and/or periodically. The RTCP packet may include a packet type, an HWD identifier, an X-direction, a Y-direction, and/or a Z-direction. For example, the RTCP packet can have a format including four bits for packet type (e.g., indicating that the RTCP includes size information of a person or object), four bits for HWD identifier (e.g., indicating or identifying the HWD 606 used to capture the directional data), and/or an 8-bit signed integer value determined for each of the X direction, Y direction, and Z direction (e.g., spanning between 0 to 255 mm).

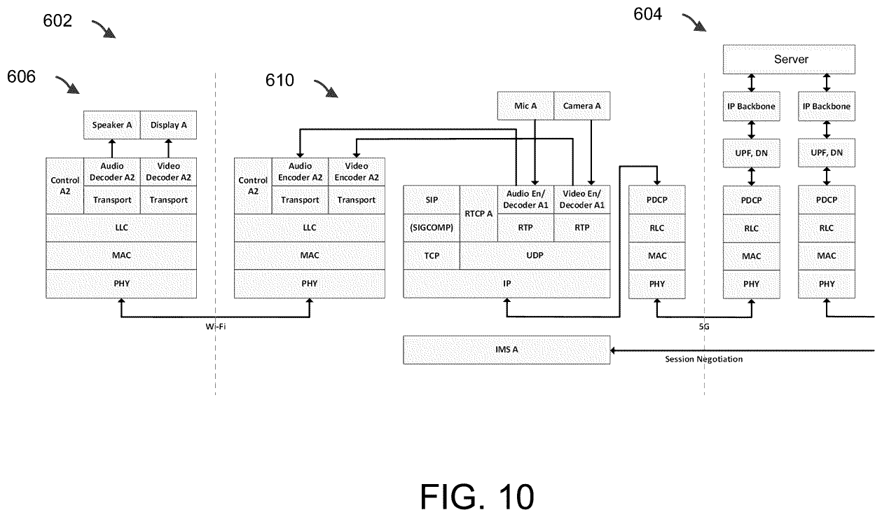

Referring now to FIG. 10, depicted is a diagram of an end-user system 602 in communication with the server 604, according to an example implementation of the present disclosure. As illustrated in FIG. 10, the HWD 606 may maintain a wireless local area network (WLAN) (such as a Wi-Fi) connection with the user device 610, and the user device 610 may maintain a cellular connection (shown as a 5G connection, though any type or form of cellular connection may be suitable) with the server 604. In this example, the imaging system 606 may be local or native to the user device 610. The HWD 606 may be configured to communicate or transmit directional data (e.g., via the WLAN connection) to the user device 610. The user device 610 may be configured to capture the A/V data and scaling data via the cameras and microphones, and transmit the A/V data and scaling data to the server 604 (e.g., via the cellular connection). As described in greater detail below, the server 604 may be configured to transmit other A/V data (e.g., of other users in the holographic communication session) back to the user device 610, which may transmit the A/V data via the WLAN connection to the HWD 606 for rendering via one or more speakers and a display.

Referring back to FIG. 6, the session data reception engine 624 of the server(s) 604 may be configured to receive A/V data 626 from the respective communications of each of the plurality of user-end systems 602 in the holographic communication session. The session data reception engine 624 may be configured to also receive the scaling data 628 (e.g., from the imaging systems 608 of the respective user-end systems 602) and the directional data 630 (e.g., from the HWDs 606 of the respective user-end systems 602). As described in greater detail below, the server(s) 604 may be configured to use the scaling data 628 to generate, determine, derive, or otherwise provide modified video data according to the scaling data 628, and can use the directional data 630 to select a bit rate for transmitting the modified A/V data to user-end systems 602 for rendering.

The server(s) 604 may include a session data processing engine 632 including a scaler 634 and a field-of-view (FOV) determiner 636. As a brief overview, the scaler 634 may be configured to change, adjust, normalize, update, or otherwise modify a proportion, relative size, or scale of objects or users depicted in video of the A/V data, according to the scaling data 628 received from the imaging system 608 of the respective user-end systems 602. The FOV determiner 636 may be configured to identify, detect, derive, compute, calculate, or otherwise determine a field-of-view of each of the respective users according to the directional data 630 received from the HWD 606 of the respective user-end systems 602.

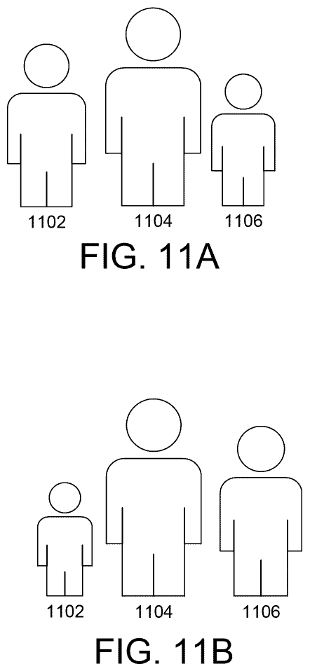

Referring now to FIG. 6 together with FIG. 11A-FIG. 11B, the scaler 634 may be configured to modify a scale of objects or user depicted in video data of the A/V data, according to the scaling data 628. Specifically, FIG. 11A and FIG. 11B show examples of frames of video data from three different user-end systems prior to and following scaling modification, according to example implementations of the present disclosure. As illustrated in FIG. 11A and FIG. 11B, the video data may originate from separate user-end systems 602(1)-602(3) and may include representations of three different users 1102, 1104, 1106. The first user 1102 may be a child having a height of approximately three feet, the second user 1104 may be an adult having a height of approximately six feet, and the third user 1106 may be an adult having a height of approximately five feet. As noted above, the user-end systems 602(1)-602(3) may be configured to provide the scaling data of the respective users 1102-1106 to the server(s) 604.

The scaler 634 may be configured to receive the video data (e.g., of the A/V data 626) and scaling data 628 from the user-end systems 602(1)-602(3). In some embodiments, the scaler 634 may be configured to modify the scale of the users or objects depicted in the video data according to the scaling data 628 from each of the user-end systems 602. The scaler 634 may be configured to modify the scale of the users or objects by increasing and/or decreasing a virtual representation of the users or objects in the video data, according to the scaling data 628 from the respective user-end system 602 relative to the scaling data 628 from other user-end systems 602. In some embodiments, the scaler 634 may be configured to modify the scale of an object or user depicted in the video data from a first user-end system 602, according to the scaling data 628 from that same user-end system 602 and scaling data 628 from other user-end systems 628. The scaler 634 may be configured to modify the scale (e.g., size, dimensions) of the object or user, to normalize the scale of the object relative to other objects. For example, assuming the scaling data 628 from a first user-end system 602 is 20% greater than the scaling data 628 from a second user-end system 602, the scaler 630 may be configured to modify the scale of objects or users depicted in video data from the first user-end system 602 by decreasing the scale of the objects (e.g., by 20%) and/or modify the scale or objects depicted in video data from the second user-end system 602 by increasing the scale of the objects (e.g., by 20%). As such, responsive to modifying the scale of the objects, each of the users or objects represented in the modified video data may have a normalized scale (e.g., across the A/V data) to show substantially accurate relative proportions.

Continuing the example shown in FIG. 11A, the scaler 634 may be configured to modify the scale of the first user 1102, to reduce the scale of the first user 1102 represented in the video data of the A/V data 626 from the first user-end system 602, according to the scaling data 628 from the first user-end system 602 (e.g., indicating a height of three feet) relative to the scaling data 628 from another user-end system 602 (e.g., indicating a height of six feet of the second user 1104). Similarly, the scaler 634 may be configured to modify the scale of the third user 1106, to increase the scale of the third user 1102 represented in the video data of the A/V data 626 from the third user-end system 602(3), according to the scaling data 628 from the third user-end system 602 (e.g., indicating a height of six feet) relative to the scaling data 628 from another user-end system 602 (e.g., indicating a height of six feet of the second user 1104 and/or indicating a height of three feet of the first user). As illustrated in FIG. 11B, following the scaler 634 modifying the scale of the users depicted in the respective video data of the A/V data 626, the modified video data corresponding to the respective users may have a proper relative scale (e.g., showing the first user 1102 as being approximately half the height as the second user 1104, the second user 1104 as being approximately 20% taller than the third user 1108, and the third user 1108 being approximately 65% taller than the first user 1102).

Referring again to FIG. 6 and FIG. 7, the FOV determiner 636 may be configured to detect, calculate, compute, identify, or otherwise determine a FOV 702 of a user corresponding to a user-end system 602, according to the directional data 630 received from the user-end system 602 (directional data 630 represented as vector 704 in FIG. 7). The FOV determiner 636 may be configured to determine the FOV 702 according to the directional data 630 and the localized map 620 maintained by the session manager engine 618. More specifically, the FOV determiner 636 may be configured to determine the FOV 702 for a particular user, according to the directional data 630 and the position of the user (e.g., user's face, eyes or gaze) in the localized map. In some embodiments, the FOV determiner 636 may be configured to identify or determine a viewing range for applying to directional data 630 to determine the FOV 702. The viewing range may be a default or standard viewing range (e.g., 20° on both left and right, and top and bottom sides of the vector 704 defined according to the directional data 630). The viewing range may be specific to the HWD 604 (e.g., and provided to the server(s) 604 as part of establishing the holographic communication session). The FOV determiner 636 may be configured determine the FOV 702 as the viewing range applied to the vector 704 in the X and Y directions. The FOV determiner 636 may be configured to determine the FOV 702 for each of the users corresponding to a respective user-end system 602.

The FOV determiner 636 may be configured to identify, detect, or otherwise determine a position of objects or users (e.g., as reflected in the localized map 620) relative to the FOV 702. The FOV determiner 636 may be configured to determine the position of objects or users relative to the FOV 702 using the localized map 620. The FOV determiner 636 may be configured to apply the FOV 702 to the localized map 620 to determine which objects or users are located in the FOV 702 of a respective user. For example, the FOV determiner 636 may be configured to project the FOV 702 onto the localized map 620 to determine which objects or users are located at positions which overlap or intersect the FOV 702. In the example shown in FIG. 7, following projecting the FOV 702 onto the localized map 620, the FOV determiner 636 may be configured to determine that users located at positions D-F intersect with or overlap the FOV 702 of the user located at position A. The FOV determiner 636 may be configured to use the indices 622(1)-622(N) to determine the position of each of the users relative to the FOV 702.

Referring to FIG. 6, the server(s) 604 may include a session data transmission engine 638. The session data transmission engine 638 may be configured to select a bit rate 640 (e.g., from a plurality of bit rates 640(1)-640(N)) for A/V data for transmission to the user-end systems 602. The session data transmission engine 638 may be configured to select the bit rate 640 for compressing/encoding/transmitting/processing the A/V data. The A/V data may be or include the modified A/V data (e.g., following the scaler 634 modifying the scale of objects according to the scaling data 628). The session data transmission engine 638 may be configured to select the bit rate 640 for given A/V data associated with a source user-end system 602 to transmit to a recipient user-end system 602, according to a position assigned to the user corresponding to source user-end system 602 with respect to the FOV 702 corresponding to the recipient user-end system 602. As such, the session data transmission engine 638 may be configured to compress/format/encode/process the same A/V data at different bit rates (corresponding to different image/audio fidelity and/or quality) for different recipient user-end systems 602, according to a position assigned (e.g., by the session manager engine 618) to the source of the A/V data (e.g., the source user-end system 602 which generated the A/V data) with respect to the FOV 702 of the recipient user-end system 602.

In some embodiments, the session data transmission engine 638 may be configured to select the bit rate 640 based on whether or not the position assigned to the user corresponding to the source user-end system 602 is within the FOV 702 corresponding to the recipient user-end system 602. In other words, the session data transmission engine 638 may be configured to select a first bit rate 640 for A/V data from source user-end systems 602 that have a position within the FOV 702 of the recipient user-end system 602, and a second bit-rate 640 for A/V data from source user-end systems 602 having a position outside of the FOV 702 of the recipient user-end systems 602. In this example, the first bit rate 640 may be higher than the second bit rate 640, thus resulting in higher quality/definition (e.g., less pixelated) video data for A/V data of users within the FOV 702. In some embodiments, the session data transmission engine 638 may be configured to select the bit rate 640 for A/V data associated with source user-end systems 602 having a position not within the FOV 702, according to a proximity of the position to the FOV 702. For example, the session data transmission engine 638 may be configured to select the bit rate 640 for A/V data associated with source user-end systems 602 to increase as the proximity of the position corresponding to the source user-end systems 602 is closer to the FOV 702.

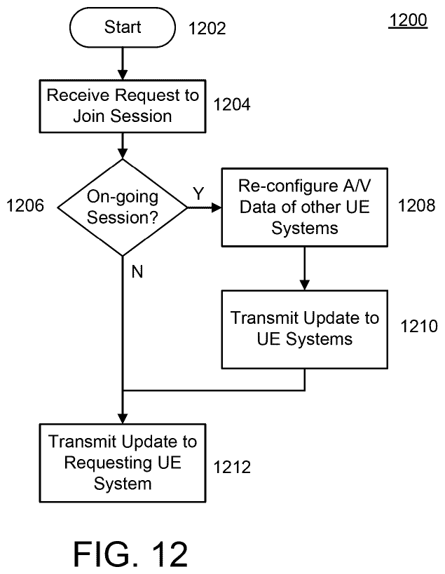

Referring now to FIG. 12, depicted is a flowchart showing an example method 1200 of updating a session condition of user-end systems, according to an example implementation of the present disclosure. The method 1200 may be performed by one or more of the devices, components, or hardware of FIG. 6, such as the server(s) 604. As a brief overview, at step 1202, the method 1200 may begin. At step 1204, the server(s) 604 may receive a request to join a session. At step 1206, the server(s) 604 may determine whether the session is on-going. At step 1208, the server(s) 604 may reconfigure A/V data for other user-end systems 602. At step 1210, the server(s) 604 may transmit an update to the user-end systems 602. At step 1212, the server(s) 604 may transmit an update to the requesting user-end system 602.

At step 1202, the method 1200 may begin. The method 1200 may begin when the server(s) 604 generate a new session. For example, the server(s) 604 may generate a new session responsive to one or more users requesting a new session on their respective user-end system 602. The server(s) 604 may establish the session responsive to the request from the user-end system 602. Thus, the server(s) 604 may begin performing the steps 1202-1212 of method 1200 responsive to a new session being established. The server(s) 604 may be configured to perform the method 1200 for each session established by the server(s) 604.

At step 1204, the server(s) 604 may receive a request to join a session. The server(s) 604 may receive the request to join a session from a user-end system 602. The user-end systems 602 may initiate a request including an identifier or other identifying information for a particular session. For example, a user of the user-end system 602 may be configured to control a user device 610 to select a link to an invitation to join a session, enter a code or identifier for a particular session, etc. The user-end system 602 may be configured to transmit the request including the identifier of the session to the server(s) 604. The user-end system 602 may be configured to transmit the request to the server(s) 604 using a cellular connection or link between the user-end system 602 and server(s) 604. The server(s) 604 may be configured to receive the request from the user-end system 602.

At step 1206, the server(s) 604 may determine whether the session is on-going. In some embodiments, the server(s) 604 may be configured to determine whether the session is on-going by performing a look-up of the session using the session identifier. The server(s) 604 may be configured to determine whether the session is on-going responsive to determining that one or more additional user-end systems 602 are currently active or otherwise included in the session. The server(s) 604 may be configured to determine that a session is not on-going responsive to determining that the identifier is not a known identifier (e.g., responsive to performing the look-up using the session identifier) and/or no users are active on the session. Where, at step 1206, the server(s) 604 determines that the session (e.g., from the request) is not an on-going session, the method 1200 may proceed to step 1212. Where, at step 1206, the server(s) 604 determines that the session is on-going, the method 1200 may proceed to step 1208.

At step 1208, the server(s) 604 may reconfigure A/V data for other user-end systems 602. In some embodiments, the server(s) 604 may reconfigure the A/V data received from user-end systems 602 currently active on the session and/or reconfigure A/V data received from the user-end system 602 joining the session. The server(s) 604 may reconfigure the A/V data by modifying the bit rate used to encode A/V traffic sent from the server(s) 604 to user-end systems. For example, with a limited display or resolution of HWDs 606, the server(s) 604 may reduce or decrease the bit rate for three-dimensional (3D) video data as more users participate in the session, and therefore fewer pixels of the display can be assigned to represent each user or objects. The server(s) 604 may adjust the session conditions (e.g., bit rate for encoding A/V data, bit rate for user-end systems 602 to encode A/V data for decoding at the server(s) 604, etc.).

At step 1210, the server(s) 604 may transmit an update to the user-end systems 602. The server(s) 604 may transmit an update to the user-end systems 602 currently in the session. The server(s) 604 may transmit an update to identify a new bit rate to be used by the user-end system(s) 602 to encode and/or decode A/V data to/from the server(s) 604. The server(s) 604 may transmit the update to each of the user-end systems 602, to set, establish, or otherwise update conditions of the session for each of the user-end systems 602. At step 1212, the server(s) 604 may transmit an update to the requesting user-end system 602. Similar to step 1210, the server(s) 604 may transmit the update to the user-end system 602 which requested to join a session. Similarly, where a session (e.g., at step 1206) is not active or on-going, the server(s) 604 may transmit an update to the user-end system 602 to establish a session with a single user-end system 602.

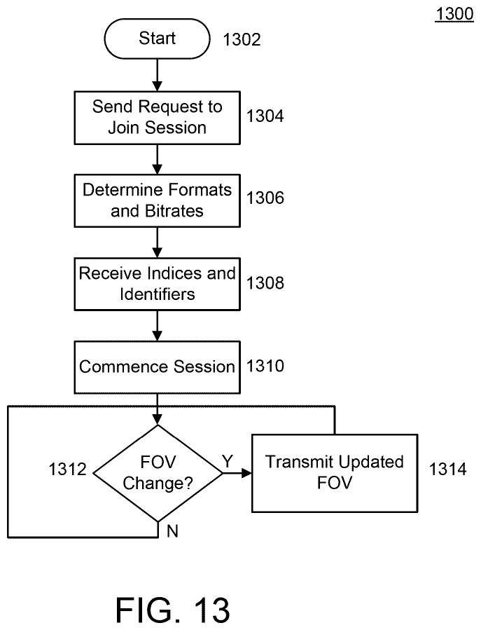

Referring now to FIG. 13, depicted is a flowchart showing an example method 1300 of updating a field-of-view (FOV) of a device, according to an example implementation of the present disclosure. The method 1300 may be performed by one or more of the devices, components, or hardware of FIG. 6, such as the user-end systems 602 and/or server(s) 604. While described as being performed by the user-end systems 602 herein, similar functionalities and steps may be performed by the server(s) 604 as described above with reference to FIG. 6-FIG. 7. As a brief overview, at step 1302, the method 1300 may begin. At step 1304, a user-end system 602 may transmit a request to join a session. At step 1306, the user-end system 602 may determine formats and bit rates. At step 1308, the user-end system 602 may receive indices and identifiers. At step 1310, the user-end system 602 may commence the session. At step 1310, the user-end system 602 may determine whether the FOV has changed. At step 1312, the user-end system 602 may transmit an updated FOV.

At step 1302, the method 1300 may begin. The method 1300 may begin when a user device 606 is turned on. The method 1300 may begin when a user device 606 establishes a connection (e.g., a local connection) with other components or elements of the user-end system 602. The method 1300 may begin when a user device 606 opens or otherwise launches an application for holographic communication sessions.

At step 1304, a user-end system 602 may transmit a request to join a session. Step 1304 may be similar to step 1204 described above with reference to FIG. 12. The user-end system 602 may transmit the request including an identifier or other information relating to the session. For example, the user-end system 602 may transmit the request using the application or resource on the user device 606, and include the identifier for the session in the request (e.g., by selecting a link for the session or typing in a code for the session, to name a few possibilities). The user-end system 602 may be configured to transmit the request to the server(s) 604.

At step 1306, the user-end system 602 may determine formats and bit rates. The user-end system 602 may identify various formatting information corresponding to A/V data captured by the user-end system 602. For example, the user-end system 602 may identify the formatting information from the application, from the server(s) 604, from local information stored on an operating system of one or more components of the user-end system 602, etc. The user-end system 602 may identify media formats for the 3D video, such as codec types, resolution of 2D video including projected 3D video elements, a maximum number of points being captured and compressed, etc.

At step 1308, the user-end system 602 may receive indices and identifiers. The user-end system 602 may receive the indices and a device identifier for the user-end system 602 from the server(s) 604. As described above, the server(s) 604 may maintain indices for each of the user-end systems 602 in a session, where each index includes (among other information) a device identifier corresponding to the user-end system 602. The server(s) 604 may transmit the indices of each of the user-end systems 602 in the session to the new user-end system 602 for constructing or otherwise maintaining a localized map. As such, where a current session is active, the server(s) 604 may assign a unique identifier and a location index for the user-end system 602 to join the current session, and can share the unique identifier and location index with other user-end systems 602. The location index may be or include a real number or integer which indicates the order of 3D objects in a clockwise or counter-clockwise fashion. The first and last objects may be assigned a special type of object identifier or location index (e.g., object_id_first, object_id_last). The last object may be assigned a largest location_index value.

At step 1310, the user-end system 602 may commence the session. The user-end systems 602 may transmit A/V data of respective users of the user-end system 602 to the server(s) 604, and the server(s) 604 may transmit A/V data of other users of other user-end systems 602 back to the user-end system 602.

At step 1310, the user-end system 602 may determine whether the FOV has changed. The user-end system 602 may determine whether the FOV has changed based on or according to sensor data of the user-end system 602. For example, the user-end system 602 may determine that the FOV has changed responsive to detecting motion from a motion sensor, such as a gyroscope and/or accelerometer. The user-end system 602 may be configured to determine the FOV has changed responsive to data of a HWD 606 of the user-end system 602. In other words, the user-end system 602 may detect the FOV (including changes thereto) based on data from one or more sensors of the HWD 606.

At step 1312, the user-end system 602 may transmit an updated FOV. In some embodiments, the user-end system 602 may transmit data corresponding to the updated FOV to the server(s) 604. The user-end system 602 may transmit data corresponding to objects or users (e.g., virtual representations of objects or users) currently within the updated FOV. In this regard, the user-end system 602 may transmit a list or other identifiers of devices having location indices within the FOV. In some embodiments, the user-end system 602 may transmit data corresponding to coordinates of the FOV to the server(s) 604. The server(s) 604 may receive the data corresponding to coordinates of the FOV, and can determine the users corresponding to user-end systems 602 assigned to a position within the FOV of the user-end system 602.

The method 1300 may loop between steps 1312 and 1314 until the corresponding user-end system 602 terminates the session (e.g., by exiting the session, turning off the HWD 606 and/or other components of the user-end system 602, etc.). When the user-end system 602 terminates the session, the method 1300 may end.

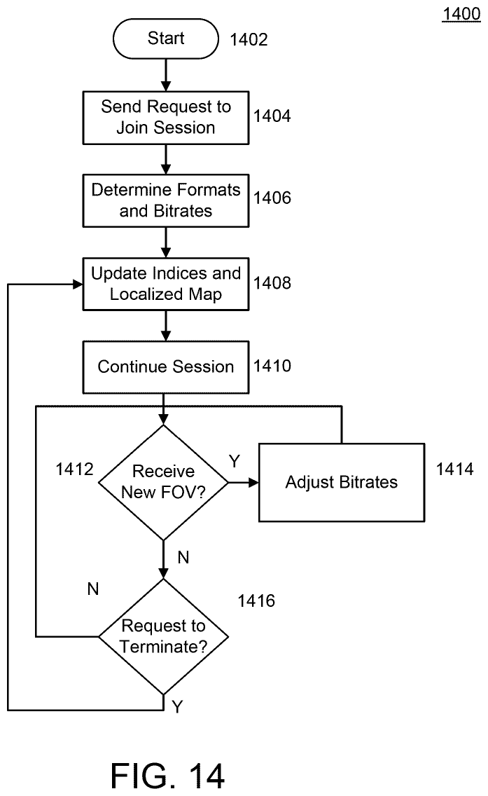

Referring now to FIG. 14, depicted is a flowchart showing an example method 1400 of managing bit rates for objects in a communication session, according to an example implementation of the present disclosure. The method 1400 may be performed by one or more of the devices, components, or hardware of FIG. 6, such as the server(s) 604. As a brief overview, at step 1402, the method 1400 may begin. At step 1404, the server(s) 604 may receive a request to join a session. At step 1406, the server(s) 604 may determine formats and bit rates. At step 1408, the server(s) 604 may update indices and a localized map. At step 1410, the server(s) 604 may continue the session. At step 1412, the server(s) 604 may determine whether a new field-of-view (FOV) has been received. At step 1414, the server(s) 504 may adjust bit rates. At step 1416, the server(s) 604 may determine whether a request to terminate the session has been received.

At step 1402, the method 1400 may begin. Similar to step 1202, the method 1400 may begin when the server(s) 604 generate a new session. For example, the server(s) 604 may generate a new session responsive to one or more users requesting a new session on their respective user-end system 602. The server(s) 604 may establish the session responsive to the request from the user-end system 602. The server(s) 604 may be configured to perform the method 1400 for each session established by the server(s) 604.

At step 1404, the server(s) 604 may receive a request to join a session. Step 1404 may be similar to step 1204 described above. At step 1406, the server(s) 604 may determine formats and bit rates. The server(s) 604 may determine media formats and bit rates for sending and receiving A/V data (e.g., to and from user-end systems 602). The server(s) 604 may determine the media formats including codec types, resolution of 2D video, maximum number of points being captured and compressed at the user-end systems, encoding bit rates for data being transmitted from the user-end systems 602 to the server(s) 604, decoding bit rates for data being transmitted from the server(s) 604 to the user-end systems 602, etc.

At step 1408, the server(s) 604 may update indices and a localized map. The server(s) 604 may update the indices and localized map, to add the user-end system 602 which generated the request at step at step 1404. The server(s) 604 may update the indices to include a new device identifier at a location index which is not currently being used by other user-end systems 602. For example, where the user-end system 602 is added to a current session, the server(s) 604 may assign a unique identifier and location index, which the server(s) 604 may share or otherwise transmit to the other user-end systems 602. Where a new user-end system is inserted between two location indices, the server(s) 604 may assign the user-end system a location index of an average between the new neighboring location indices (e.g., for adjacent user-end systems 604). Additionally, where a new object or user-end system is inserted between the first and last object, the new object or user-end system 602 may be assigned (e.g., by the server(s) 604) a value of a location index larger than the previous last object and the user-end system 602 may be the new last object. Additionally, where a user-end system 602 leaves the conference session which was previously the first object (or last object), the server(s) 604 may assign the next (or previous) object as the first object (or last object) by updating the device identifier and location index.

At step 1410, the server(s) 604 may continue the session. At step 1412, the server(s) 604 may determine whether a new field-of-view (FOV) has been received. In some embodiments, the server(s) 604 may determine whether the new FOV has been received from one of the user-end systems 602. The server(s) 604 may receive data indicative of a new FOV responsive to performance of the steps of method 1300 (e.g., step 1314). The server(s) 604 identify or determine a new FOV based on the data received from the user-end system. For example, the data may be or include directional data. The directional data may be a direction of a gaze of the user corresponding to the user-end system 602, a group of device identifiers included in the FOV of the user-end system 602, etc. The server(s) 604 may identify the user-end systems 602 corresponding to locations within the FOV of the user-end system 602 (e.g., having the updated FOV).

At step 1414, the server(s) 504 may adjust bit rates. The server(s) 604 may adjust bit rates for compressing/formatting/processing/encoding A/V data transmitted from the server(s) 504 to a user-end system 602. The server(s) 604 may adjust bit rates to compress/format/process/encode A/V data based on which user-end systems 602 correspond to a location within the FOV of the user-end system 602 and which user-end systems 602 correspond to a location outside of the FOV of the user-end system 602. The server(s) 604 may adjust bit rates to compress/format/process/encode A/V data from user-end systems 602 corresponding to locations within the FOV at a higher bit rate than A/V data from user-end systems 602 corresponding to locations outside of the FOV. The server(s) 604 may select bit rates for compressing/formatting/processing/encoding A/V data from user-end systems corresponding to locations outside of the FOV to get progressively larger (e.g., closer to the bit rate for user-end systems 602 corresponding to locations within the FOV) as the location approaches the FOV. In this regard, the bit rate used for compressing/formatting/processing/encoding A/V data may progressively increase as the location corresponding to the source user-end system 602 of the A/V data approaches the FOV. The server(s) 604 may compress/format/process/encode the A/V data for transmission to a respective user-end system 602 according to the selected bit rate for the A/V data (as selected based on locations of the source user-end systems 602 with respect to the FOV of the user of the respective user-end system 602).

At step 1416, the server(s) 604 may determine whether a request to terminate the session has been received. The method 1400 may thus loop between step 1412 and 1414 until a request from an end-user system 602 to terminate the session is received. Where a request is received at step 1416, the method 1400 may loop back to step 1408 to update the indices and localized map. The method 1400 may continue through the steps 1408 through 1416 until there is no more user-end systems 602 joined to/in the session.

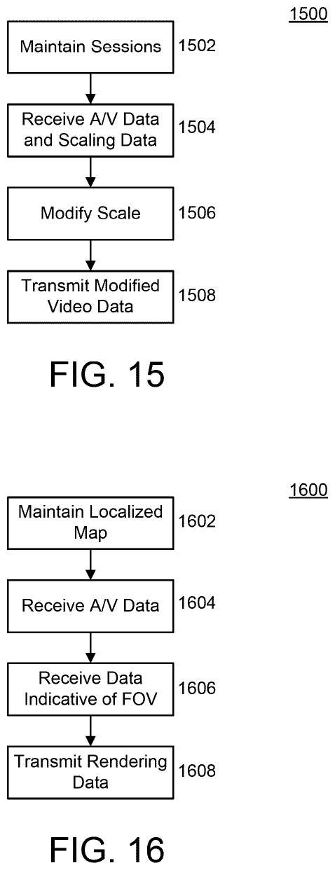

Referring now to FIG. 15, depicted is a flowchart showing an example method 1500 of signaling information for holographic communications, according to an example implementation of the present disclosure. The method 1500 may be performed by the devices, components, or hardware described above with reference to FIG. 1-FIG. 14. As a brief overview, at step 1502, one or more server(s) may maintain sessions. At step 1504, the server(s) may receive audio/video (A/V) data and scaling data. At step 1506, the server(s) may modify a scale. At step 1508, the server(s) may transmit modified video data.

At step 1502, one or more server(s) may maintain sessions. In some embodiments, the server(s) may maintain a first session with a first device of a first user and one or more second sessions with one or more second devices of one or more second users. In some embodiments, the method 1500 may being prior to step 1502, proceed with establishing a plurality of sessions (e.g., including the first and second sessions). The server(s) may establish the first session with a first device of a first user and the one or more second sessions with one or more second devices of one or more second users. The server(s) may establish the first and second sessions responsive to or according to a request for a conference call between the first device and the second device(s). The server(s) may establish the first and second session(s) responsive to the first and second device(s) joining the session (or conference call) between the respective devices.

At step 1504, the server(s) may receive audio/video (A/V) data and scaling data. In some embodiments, the server(s) may receive audio/video (A/V) data of a first user and scaling data for the first user via the first session from the first device. The first device may capture, detect, or otherwise identify the A/V data and scaling data. For example, the first device may receive the A/V data and scaling data from an imaging system communicably coupled to the first device. The first device may forward, transmit, send, or otherwise provide the A/V data and scaling data to the server(s). The server(s) may receive the A/V data of the first user at a periodicity or frequency set or established as part of maintaining the holographic communication session between the device(s). The server(s) may receive the scaling data at a second frequency. For example, the server(s) may receive the scaling data at various intervals, which may be every 10 seconds, 30 seconds, one minute, etc. The server(s) may thus receive the scaling data separate from the A/V data of the first user.

In some embodiments, the server(s) may receive second A/V data of second users and second scaling data. The server(s) may receive the second A/V data and second scaling data on the one or more second sessions maintained (e.g., at step 1502) with the second device(s). Similar to the first device, the second device(s) may transmit the second A/V data and second scaling data received from a HWD communicably coupled to the second device(s), to the server(s) on the second sessions. The second device(s) may transmit the second A/V data and second scaling data at intervals similar to the first A/V data and scaling data (e.g., from the first device). The server(s) may receive the second A/V data and second scaling data responsive to the second devices transmitting the A/V and scaling data.

At step 1506, the server(s) may modify a scale. In some embodiments, the server(s) may modify a scale of the first user (or object) represented in video data of the A/V data according to the scaling data. The server(s) may modify the scale of the first user represented in the video data according to the scaling data from the corresponding first device. The server(s) may modify the scale of the first user according to the scaling data from each of the devices (e.g., the first device and the second devices). The server(s) may modify the scale of the first user, to normalize the scale of the first user from the first A/V data relative to the scale of the second user(s) represented in the video data of the second A/V data. As such, the server(s) may, in some embodiments, modify a scale of the second users represented in the second video data of the second A/V data according to the second scaling data (and first scaling data). In some embodiments, the server(s) may modify the scale of the user represented in the first video data according to the first scaling data and the second scaling data. Similarly, the server(s) may modify the scale of the second user(s) represented in the second video data according to the first scaling data and the second scaling data. The server(s) may modify the scale of the first user represented in the first video data to match the scale of one or more second users represented in the second video data, according to the first scaling data and the second scaling data. In this regard, the scale of the users across the A/V data from the user devices may be normalized by the server(s) according to the scaling data from the respective user devices.

At step 1508, the server(s) may transmit modified video data. In some embodiments, the server(s) may transmit modified A/V data (e.g., following modifying the scale of the video data) of the first user to the one or more second devices (e.g., via the second session(s)) for rendering to the one or more second users. The server(s) may transmit the modified A/V data to each of the second devices of the second users, to render the modified visual data (e.g., following adjusting the scale of the first user in the visual data) to the second user. In some embodiments, the server(s) may also transmit modified second A/V data of the second user(s) to the first device via the first session, for rendering to the first user of the first device.

Referring now to FIG. 16, depicted is a flowchart showing an example method 1600 of improving data stream processing according to a field-of-view, according to an example implementation of the present disclosure. The method 1600 may be performed by the devices, components, or hardware described above with reference to FIG. 1-FIG. 14. As a brief overview, at step 1602, one or more servers may maintain a localized map. At step 1604, the server(s) may receive audio/video data. At step 1606, the server(s) may receive data indicative of a field-of-view. At step 1608, the server(s) may transmit rendering data. Any one or more of the steps may be optional and/or can be re-ordered relative to other steps.

At step 1602, one or more servers may maintain a localized map. In some embodiments, the server(s) may maintain a relative position of each of a plurality of users with respect to a localized map. The server(s) may maintain the relative position assigned to a respective device of each of the plurality of users with respect to a localized map. In some embodiments, the server(s) may assign the relative position for each user device of the corresponding user included in the session. The server(s) may maintain a localized map including a device identifier and the corresponding position assigned to each respective device. In some embodiments, the server(s) may maintain the localized map as location indices for each user. A location index of the indices may include or otherwise indicate a position assigned to a user with respect to at least some of the plurality of users. In some embodiments, the location index may include or otherwise indicate a position assigned to a respective user with respect to each of the plurality of users. In some embodiments, the location index may include or otherwise indicate a position assigned to a respective user with respect to the nearest neighbors of the user (e.g., users assigned to positions

[symbol]

At step 1604, the server(s) may receive audio/video data. In some embodiments, the server(s) may receive audio/video (A/V) data of a first user from a first device. The server(s) may receive the A/V data of the user on a session maintained between the server and the first device. The first device may detect, determine, identify, or otherwise generate the A/V data responsive to the A/V data being captured by an imaging system communicably coupled to the first device. The first device may transmit the A/V data via the session to the server.

At step 1606, the server(s) may receive data indicative of a field-of-view (FOV). In some embodiments, the server(s) may receive the data indicative of a FOV of a second user of the plurality of users from a second device. The data may include directional data indicative of a gaze of the second user, a vector, angular span or coordinates corresponding to the FOV, or identifiers corresponding to a subset of the plurality of users having respective positions within the FOV of the second user, etc. The second device may detect, determine, or otherwise identify the FOV or data indicative of the FOV, according to data from one or more sensors of a head wearable device (HWD) communicably coupled to the second device. The second device may transmit the data via the second session to the server(s). The server(s) may determine or identify one or more devices associated with positions within the FOV of the second user. In some embodiments, the server(s) may determine the FOV based on the data received from second device (e.g., by applying a viewing range to the vector or coordinates of the gaze), and determine which devices are assigned to a position (e.g., based on the localized map) which is within the FOV. In some embodiments, the server(s) may determine which devices are assigned to a position within the FOV based on the device identifiers included as the data indicative of the FOV from the second device.

In some embodiments, the server(s) may select a bit rate from a plurality of bit rates according to a position of the second user with respect to the directional data indicative of the gaze of the first user. For example, the server(s) may select bit rates for A/V data of source user devices according to the position assigned to the source user devices relative to the FOV determined for the user device which is to receive the A/V data. The server(s) may select bit rates for compressing/formatting/processing/encoding A/V data for transmission to the user devices. In this regard, for a given source user device, the server(s) may select different bit rates for compressing/formatting/processing/encoding the A/V data from the source user device for transmission to different recipient user devices according to a location or position assigned to the source user device with respect to a FOV of the recipient user device.

In some embodiments, the server(s) may identify a subset of location indices for a subset of users within a view range (or FOV) of the second user, based on the location index for the second user and the directional data. The server(s) may select the bit rate for rendering data of the subset of users according to the location indices associated with the users within the FOV of the second user. In some embodiments, the server(s) may select the bit rate for the subset of users assigned to positions within the view range of the second user to be higher than bit rates for rendering data of other users outside of the subset (e.g., outside of the view range). In some embodiments, the server(s) may select bit rates for A/V data of other users outside of the view range according to a proximity of the location index for the other users with respect to the view range. For example, the server(s) may select the bit rate for rendering data of a respective user of the other users to increase as the proximity of the location index for the respective user decreases with respect to the viewing range.

At step 1608, the server(s) may transmit rendering data. In some embodiments, the server(s) may transmit rendering data to the second device which corresponds to the first A/V data. The server(s) may transmit the rendering data to the second device which is compressed/formatted/processed/encoded at the bit rate selected according to: the directional data and/or the relative position of the second user with respect to the localized map. The server(s) may transmit the rendering data responsive to compressing/formatting/processing/encoding the rendering data at the selected bit rate. The server(s) may transmit the rendering data to the second device for decompression/decoding/processing and rendering (e.g., via a HWD communicably coupled to the second device). The server(s) may similarly receive directional data indicative of the gaze of other users, may receive A/V data of the second user, and can transmit rendering data corresponding to the second A/V data compressed/formatted/processed/encoded at a second bit rate. In this regard, the server(s) may compress/format/encode/process A/V data for transmission to user devices at different bit rates based on whether the A/V data corresponds to a position which is within the FOV of the user device which his receiving the compressed/formatted/processed/encoded A/V data.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method comprising:
receiving, by one or more servers, from a first device, first audio/video (A/V) data of a first user of the plurality of users;
receiving, by the one or more servers, from a second device, data indicative of a field-of-view (FOV) of a second user of the plurality of users; and
transmitting, by the one or more servers, to the second device, rendering data corresponding to the first A/V data at a bit rate selected according to the data indicative of the FOV.

2. The method of claim 1, further comprising:
receiving, by the one or more servers, from the first device, second data indicative of a second FOV of the first user;
receiving, by the one or more servers, from the second device, second A/V data of the second user; and
transmitting, by the one or more servers, to the first device, rendering data corresponding to the second AV data at a second bit rate selected according to the second data indicative of the second FOV.

3. The method of claim 1, further comprising:
selecting, by the one or more servers, the bit rate from a plurality of bit rates according to a position of the second user with respect to the FOV of the first user.

4. The method of claim 1, comprising:
maintaining, by the one or more servers, a relative position of each of a plurality of users with respect to a localized map; and
maintaining, by the one or more servers, a location index for each user of the plurality of user, the location index indicative of a position of the user with respect to at least some of the plurality of users in the localized map.

5. The method of claim 4, further comprising:
identifying, by the one or more servers according to the location index for the second user and the FOV of the second user, a subset of location indices for a subset of users within the FOV of the second user; and
selecting, by the one or more servers, a bit rate for compressing A/V data of the subset of users within the FOV of the second user that is higher than bit rates for compressing A/V data of other users of the plurality of users outside the FOV.

6. The method of claim 5, further comprising:
selecting, by the one or more servers, the bit rates for compressing the A/V data of the other users, according to proximity of location indices for the other users with respect to the FOV.

7. The method of claim 6, wherein a bit rate for compressing A/V data of a respective user of the other users increases as proximity of a location index for the respective user decreases with respect to the FOV.

8. The method of claim 1, wherein the data indicative of the FOV of the second user comprises at least one of directional data indicative of a gaze of the second user, a vector, angular span or coordinates corresponding to the FOV, or identifiers corresponding to a subset of the plurality of users having respective positions within the FOV of the second user.

9. The method of claim 1, wherein the A/V data comprises three-dimensional (3D) video data and spatial audio data.

10. One or more servers comprising:
one or more processors configured to:
receive, from a first device, audio/video (A/V) data of a first user of the plurality of users;
receive, from a second device, data indicative of a field-of-view (FOV) of a second user of the plurality of users; and
transmit, to the second device, rendering data corresponding to the first A/V data at a bit rate selected according to the data indicative of the FOV.

11. The one or more servers of claim 10, wherein the one or more processors are configured to:
receive, from the first device, second data indicative of a second FOV of the first user;
receive, from the second device, second A/V data of the second user; and
transmit, to the first device, rendering data corresponding to the second AV data at a second bit rate selected according to the second data indicative of the second FOV.

12. The one or more servers of claim 10, wherein the one or more processors are configured to:
select the bit rate from a plurality of bit rates according to a position of the second user with respect to the FOV of the first user.

13. The one or more servers of claim 10, wherein the one or more processors are configured to:
maintain a relative position of each of a plurality of users with respect to a localized map; and
maintain a location index for each user of the plurality of user, the location index indicative of a position of the user with respect to at least some of the plurality of users in the localized map.

14. The one or more servers of claim 13, wherein the one or more processors are configured to:
identify, according to the location index for the second user and the FOV of the second user, a subset of location indices for a subset of users within the FOV of the second user; and
select a bit rate for compressing A/V data of the subset of users within the FOV of the second user that is higher than bit rates for compressing A/V data of other users of the plurality of users outside the FOV.

15. The one or more servers of claim 14, wherein the one or more processors are configured to:
select the bit rates for compressing the A/V data of the other users, according to proximity of location indices for the other users with respect to the FOV.

16. The one or more servers of claim 15, wherein a bit rate for compressing A/V data of a respective user of the other users increases as proximity of a location index for the respective user decreases with respect to the FOV.

17. The one or more servers of claim 10, wherein the data indicative of the FOV of the second user comprises at least one of directional data indicative of a gaze of the second user, a vector, angular span or coordinates corresponding to the FOV, or identifiers corresponding to a subset of the plurality of users having respective positions within the FOV of the second user.

18. The one or more servers of claim 10, wherein the A/V data comprises three-dimensional (3D) video data and spatial audio data.

19. A non-transitory computer readable medium storing instructions that, when executed by one or more processors, cause the one or more processors to:
receive, from a first device, audio/video (A/V) data of a first user of the plurality of users;
receive, from a second device, data indicative of a field-of-view (FOV) of a second user of the plurality of users; and
transmit, to the second device, rendering data corresponding to the first A/V data at a bit rate selected according to the data indicative of the FOV.

20. The non-transitory computer readable medium of claim 19, wherein the instructions further cause the one or more processors to:
receive, from the first device, second data indicative of a second FOV of the first user;
receive, from the second device, second A/V data of the second user; and
transmit, to the first device, rendering data corresponding to the second AV data at a second bit rate selected according to the second data indicative of the second FOV.
